(19) United States
(12) Patent Application Publication
(10) Pub. No.: US 2004/0072610 A1
(43) Pub. Date: Apr. 15, 2004

(54) Gaming machine and method having symbols capable of displaying movement

(76) Inventors: Rick White, Rancho Mirage, CA (US); David Forman, Rancho Mirage, CA (US)

Correspondence Address: WEISS & MOY PC, 4204 NORTH BROWN AVENUE, SCOTTSDALE, AZ, 85251, US

(21) Appl. No.: 10/268,642

(22) Filed: Oct. 11, 2002

(51) Int. Cl. A63F 13/00

(52) U.S. Cl. 463/20

(57) ABSTRACT

A gaming machine providing symbols, located in a display area, that are capable of displaying movement. In one embodiment, the gaming machine is a slot machine. With slot machines, the symbols are located on reels and appear on one or more pay lines located in the display area. The slot machine may be programmed so that, when a symbol appears in a pay line as part of a winning combination, it will display movement across all or some portion of the pay line. Movement may also be provided when a non-winning combination is present in the pay line. The gaming machine may also be a video poker terminal, video bingo terminal, or other gaming machine.

### FIELD OF THE INVENTION

This invention relates generally to gaming machines and, more particularly, to gaming machines providing symbols capable of displaying movement.

### BACKGROUND OF THE INVENTION

Gaming machines provide players with the opportunity to wager a sum of money for the chance of winning a larger amount in the event a winning outcome is achieved. Slot machines represent one type of gaming machines. These typically have a plurality of reels, with three and five reel machines being relatively common (though two and four reel machines are also known).

Generally, each reel on the slot machine displays different symbols thereon. The pay line represents a line, across the reels, where achievement of a winning combination of symbols produces a jackpot. Traditionally, the pay line was in the middle of the slot window, though it is now common for there to be three, five, seven, or even more pay lines. The types of winning combinations as well as the jackpot amounts payable upon their achievement are generally set forth in a pay table displayed on or about the machine.

Early slot machines featured mechanical reels, with symbols painted thereon. Typical symbols include cherries, bars, plums, and bells. Later, electronic slot machines were developed, having video displays. The video displays used in prior art machines essentially duplicate the mechanical reel display, with symbols being the subject of electronic rather than painted display. However, even with the overwhelming majority of prior art electronic slot machines, the symbols when viewed at the time the reels come to a stop are stationary. Recently, some electronic machines have been introduced where, in the event of a winning combination, one or more individual symbols will display animated movement of some kind, within the confines of the reel.

A need existed for a gaming machine, including for example a slot machine, that increases player excitement and enjoyability. Specifically, the machine should display movement across a pay-line (and not solely within the reel), where a winning combination is presented. It is further preferred to provide a machine with audio effects that are also provided upon achievement of a winning combination, and that are thematically consistent with the visual display. Still further, it is preferred to provide a gaming machine with an animated symbol display, preferably across the pay line although optionally solely within one or more reels, when a losing combination is present.

The present invention satisfies these needs and provides other, related, advantages.

### SUMMARY OF THE INVENTION

It is an object of the present invention to provide a gaming machine and method for providing a moving or animated symbol, displaying movement across a pay line when a winning combination is present.

It is a further object of the present invention to provide a gaming machine and method that with audio effects, in combination with an animated display, that are also provided upon achievement of a winning combination, and that are thematically consistent with the visual display.

It is a still further object of the present invention to provide a gaming machine and method that provides an animated symbol display, across a pay line, when a losing combination is present.

It is a still further object of the present invention to provide a gaming machine and method that provides an animated symbol display, solely within one or more reels, when a losing combination is present.

Other objects, features and advantages of the present invention will become apparent from a consideration of the following detailed description.

### BRIEF DESCRIPTION OF THE PREFERRED EMBODIMENTS

In accordance with one embodiment of the present invention, a gaming machine with a moving display is disclosed. The gaming machine comprises, in combination: a money receiver; a play activator; a display area having two or more reels therein; and at least one symbol being visible in each said reel in said display area; wherein at least one of said symbols is capable of movement from one said reel to another said reel.

In accordance with another embodiment of the present invention, a method for providing a moving display for a gaming machine is disclosed. The method comprises the steps of: providing a gaming machine having: a money receiver; a play activator; a display area having two or more reels therein; and at least one symbol being visible in each said reel in said display area; wherein at least one of said symbols is capable of movement from one said reel to another said reel; activating said play activator; and displaying at least one symbol in said display area moving from one said reel to another said reel.

In accordance with still another embodiment of the present invention, a method for providing a moving display for a gaming machine is disclosed. The method comprises the steps of: providing a gaming machine having: a money receiver; a play activator; a display area having two or more reels therein; and at least one symbol being visible in each said reel in said display area; wherein at least one of said symbols is capable of being displayed one said reel in a first, static condition and in a second, moving condition; activating said play activator; and displaying at least one symbol in one said reel in said second, moving condition.

### BRIEF DESCRIPTION OF THE DRAWINGS

FIG. 1 is a perspective view of a gaming machine consistent with the present invention.

FIG. 2 is a front view of three reels in a display area of a gaming machine consistent with a present invention, showing movement of symbols when a winning combination occurs.

FIG. 3 is a front view of three reels in a display area of a gaming machine consistent with a present invention, showing movement of symbols when a losing combination occurs.

FIG. 4 is a front view of three reels in a display area of a gaming machine consistent with a present invention, showing movement of symbols when a winning combination occurs.

FIG. 5 is a front view of three reels in a display area of a gaming machine consistent with a present invention, showing movement of symbols when a losing combination occurs.

FIG. 6 is a front view of three reels in a display area of a gaming machine consistent with a present invention, showing movement of symbols when a winning combination occurs.

### DETAILED DESCRIPTION OF THE PREFERRED EMBODIMENTS

Referring first to FIG. 1, an embodiment of the gaming machine of the present invention is shown. In this embodiment, the gaming machine is a slot-type machine 10 (hereinafter “slot 10”). It should be noted, however, that the term “gaming machine” as used herein is intended to include any vending type of automated gaming device; i.e., a machine that accepts money from a player, allows a player to play a game, displays symbols as part of the play of the game, and determines whether there has been a winning outcome based on the symbols displayed. Video bingo, video poker, and video bingo reflect a non-exhaustive listing of other types of gaming machines, in addition to slot machines, that are intended to be included within the scope of the term “gaming machine.” The term “symbol” should be understood to include anything that can be depicted on a slot machine reel, a card of the type that might be displayable on a poker machine, indicia that might be displayed on a bingo machine, or any other depiction that might be used as part of the play of a game on a gaming machine.

The slot 10 comprises a slot window/video display area 12 (hereinafter “display area 12”), a money receiver 14, and a play activator 16. It should be noted that the money receiver 14 could be adapted to receive coins, tokens, bills, cards (including player cards with credits, credit cards, debit cards, or the like), or other indicia of value. With respect to the play activator 16, it should be understood that this can be a lever as shown in FIG. 1, or a button, or other device, the activation of which will initiate play for the slot 10.

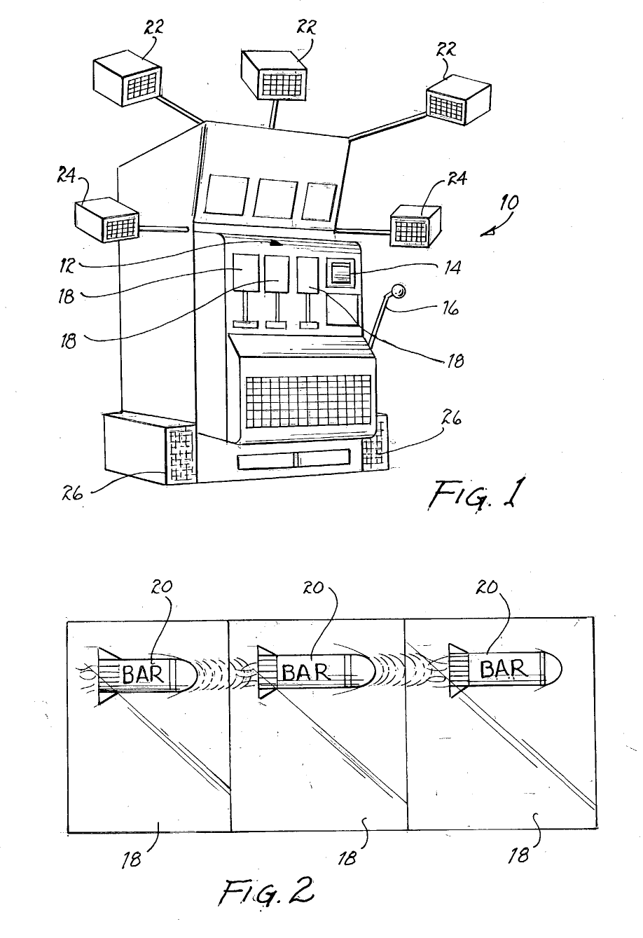

The display area 12 displays a plurality of reels 18. While three reels 18 are shown in this example, it should be understood, as noted above, that the number of reels provided for a slot machine may be varied as desired. Each reel 18 has a plurality of symbols 20 thereon. (See FIGS. 2-6). (The display area 12 includes all of the symbols 20 visible to a player.)

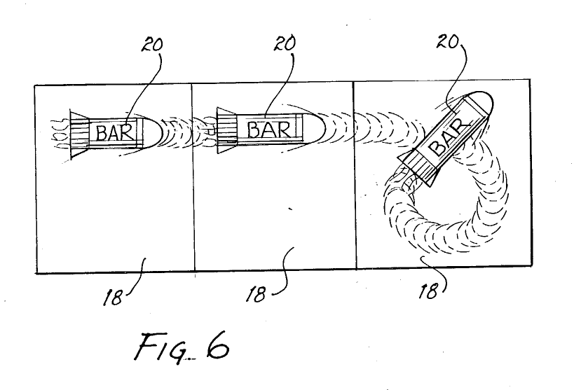

In a prior art slot 10, a winning combination may be, for example, three cherries in a row. As illustrated in FIGS. 2, 4 and 6 herein, at least one and preferably all symbols 20 that can form part of a winning combination are programmed to provide either a first, static display, or a second, moving display. For example, where the symbols 20 included in a winning combination are rockets (see FIGS. 2 and 6), one or more of them can, upon appearing in the pay line, move across the pay line in any desired, visually-pleasing manner. For example, as shown in FIG. 2, the rockets could move straight across the pay line. Or, as shown in FIG. 6, a rocket can fly across the pay line and do a loop.

As shown in FIG. 4, a change in appearance of a symbol is also possible. In this example, the middle and left-most symbols 20 show movement across the pay line, while the right-most symbol 20, a cherry, displays a happy face and rays. The types of possible displays are essentially limitless, with the only limitation being that, as part of a winning combination, there should be movement at least from one reel 18 to a second reel 18 and preferably all the way across the pay line.

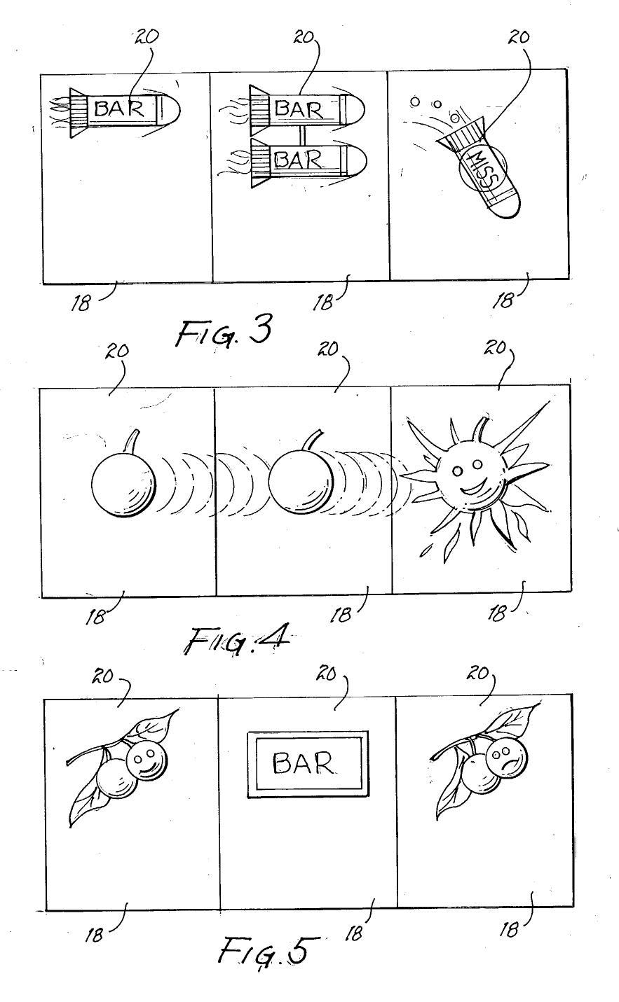

On the other hand, where a symbol 20 appears in the pay line but not as part of a winning combination, it will generally be preferred, except as discussed below, that they appear in their first, static condition, as shown by way of example in left-most reel 18 in FIG. 3. It should be noted that all symbols 20 displayed on a reel 18 may be capable of movement, or only some and even as few as one symbol 20 may have such capability.

It would also be possible to provide, in combination with the animated, moving display, an audio indication that a winning combination has taken place. Although not required, such an audio indication should, preferably, be thematically consistent with the visual display. Thus, if the symbol 20 is a firecracker, and if the visual effect is that of a firecracker exploding, the audio indication could be that of an exploding firecracker. If the symbol 20 is a cartoon character, such as Fred Flinstone, and if the visual effect is that of Fred Flinstone celebrating, the audio indication could be something the character would say, like: “Yabba Dabba Doo.” Another example would be a symbol 20 that is a bell, with the visual effect showing the bell shaking as if being rung and the audio effect being that of a ringing bell.

Referring again to FIG. 1, a possible speaker configuration is shown for a slot 10, which will provide audio effects in a particularly effective and entertaining, surround-sound type of manner. The slot 10 preferably has a plurality of tweeters 22 positioned proximate a top of the slot 10, a mid-range 24 on each side of the slot 10 located below the tweeters 22, and a bass 26 on each side of the slot 10 located near the ground.

Referring now to FIGS. 3 and 5, although it is preferred that the visual effect take place to reflect that a wining outcome has been achieved, it may also be desired to provide a visual effect of one or more symbols 20 to reflect a near miss or other non-winning outcome, such as when some though not all symbols 20 forming part of a winning combination appear in the pay line. In such instance, it may be preferred to provide a visual effect that is consistent with losing/mourning rather than winning/celebration. (It would be particularly desirable to provide such effect when a near-miss has taken place; where, for example, a player has received two of three symbols 20 needed to achieve a winning combination.) For example, as shown in FIG. 3, a symbol 20 that is a rocket could crash, instead of fly as shown in FIG. 2 or 6. As another example, as shown in FIG. 5, a symbol 20 that has a facial expression could be caused to shown sadness instead of joy. Of course, the possible ways in which mourning or celebration can be depicted are essentially unlimited.

It should be noted that where a losing combination is present, movement could be across reels 18 or, optionally, such movement of one or more symbols 20 could be confined to the reel 18 in which any moving symbol 20 is located—with a symbol 20 changing from a first, static condition to a second, moving condition.

In this embodiment, it would also be possible to provide, in combination with the animated, moving display consistent with a losing combination, an audio indication that a losing combination has taken place. Although not required, such an audio indication should, preferably, be thematically consistent with the visual display.

Where the gaming machine is, for example, a video poker terminal, the symbols 20 would be those present on typical playing cards. Visual effects can be provided for these images, with face cards being able to celebrate, or mourn, as desired, and with the indicia on non-face cards (i.e., diamonds, hearts, clubs, and spades) being able to explode, move or otherwise be involved in a moving display. Again, an accompanying audio effect can also be provided.

It should be noted further that the gaming machine may be of either the Class II or Class III type. Generally, a Class III machine, according to current gaming regulations, is one in which the outcome is determined purely by chance. Whatever the game played, the outcome is typically generated electronically, in a random manner, by a random number generator or EPROM. The player plays only against the machine, and no skill is required.

With a Class II machine, typically used in the play of bingo, there are a number of requirements. Players must play against each other, requiring a networking of gaming machines. Also, each play of a game must produce at least one winner. Still further, in some jurisdictions there may be a need for a ball draw rather than a random number generator to determine game outcome, although random number generators may be used in some places. In addition, there is a need for some player skill, which is generally satisfied by the player being required to daub his or her card and claim his or her winning outcome.

The present invention could be utilized on a gaming machine that is classified either as a Class II or a Class III machine.

It should be apparent that accomplishment of a desired moving display requires programming of the software for the video display for the gaming machine to provide for the generation of a desired moving display for one or more symbols 20, rather than a static display, upon occurrence of a particular event. As discussed above, the particular event will generally be a winning outcome, though it could also be a near miss or other losing outcome. Where an audio indication is also to be provided, the software for the gaming machine will need to be adapted to provide this.

While the invention has been particularly shown and described with reference to preferred embodiments thereof, it will be understood by those skilled in the art that the foregoing and other changes in form and details may be made therein without departing from the spirit and scope of the invention.

I claim:

1. A gaming machine with a moving display comprising, in combination:
a money receiver;
a play activator;
a display area having two or more reels therein; and
at least one symbol being visible in each said reel in said display area;
wherein at least one of said symbols is capable of movement from one said reel to another said reel.

2. The gaming machine of claim 1 wherein said gaming machine is a slot machine.

3. The gaming machine of claim 1 wherein said gaming machine is a video poker terminal.

4. The gaming machine of claim 1 wherein said gaming machine is a video bingo terminal.

5. The gaming machine of claim 1 wherein said gaming machine is a Class II machine.

6. The gaming machine of claim 1 wherein said gaming machine is a Class III machine.

7. The gaming machine of claim 1 further comprising means for providing an audio indication that a winning combination has taken place, concurrent with display of said movement.

8. The gaming machine of claim 7 wherein said means comprises a plurality of tweeters positioned proximate a top of said gaming machine, a mid-range on each side of said gaming machine located below said tweeters, and a bass on each side of said gaming machine located near the ground.

9. The gaming machine of claim 7 wherein said audio indication is thematically consistent with said movement.

10. A method for providing a moving display for a gaming machine, comprising the steps of:
providing a gaming machine having:
a money receiver;
a play activator;
a display area having two or more reels therein; and
at least one symbol being visible in each said reel in said display area;
wherein at least one of said symbols is capable of movement from one said reel to another said reel;
activating said play activator; and
displaying at least one symbol in said display area moving from one said reel to another said reel.

11. The method of claim 10 wherein said gaming machine is adapted to produce a winning outcome upon display of a predetermined combination of said symbols in said display area and further comprising the step of displaying at least one of said symbols moving from one said reel to another said reel when it forms part of said pre-determined combination in said designated portion.

12. The method of claim 10 wherein said gaming machine is adapted to produce a winning outcome upon display of a predetermined combination of said symbols in said display area and further comprising the step of displaying at least one of said symbols moving from one said reel to another said reel when it is displayed in said display area but when said pre-determined combination is not present in said display area.

13. The method of claim 10 wherein said gaming machine is a slot machine.

14. The method of claim 10 wherein said gaming machine is a video poker terminal.

15. The method of claim 10 wherein said gaming machine is a video bingo terminal.

16. The method of claim 10 further comprising the step of providing means for providing an audio indication that a winning combination has taken place, concurrent with display of said movement.

17. The method of claim 16 wherein said audio indication is thematically consistent with said movement.

18. The method of claim 10 further comprising the step of providing means for providing an audio indication that a losing combination has taken place, concurrent with display of said movement.

19. The method of claim 18 wherein said audio indication is thematically consistent with said movement.

20. A method for providing a moving display for a gaming machine, comprising the steps of:
providing a gaming machine having:
a money receiver;
a play activator;
a display area having two or more reels therein; and
at least one symbol being visible in each said reel in said display area;
wherein at least one of said symbols is capable of being displayed one said reel in a first, static condition and in a second, moving condition;
activating said play activator; and
displaying at least one symbol in one said reel in said second, moving condition.
